(19) United States
(12) Patent Application Publication
(10) Pub. No.: US 2021/0399951 A1
(43) Pub. Date: Dec. 23, 2021

(54) BROADBAND ACCESS MODEM TRAFFIC CONTROLLER

(71) Applicant: CenturyLink Intellectual Property LLC, Broomfield, CO (US)

(72) Inventors: Steven Casey, Littleton, CO (US); Stephen Opferman, Denver, CO (US); Pradeep Rajashekar, Bengaluru (IN)

(73) Assignee: CenturyLink Intellectual Property LLC, Broomfield, CO (US)

(21) Appl. No.: 16/904,312

(22) Filed: Jun. 17, 2020

(51) Int. Cl. H04L 12/24; H04L 12/26; H04W 88/08

(52) U.S. Cl. CPC H04L 41/0896; H04W 88/08; H04L 43/16; H04L 43/0876

(57) ABSTRACT

The application describes a network-access device with multiple different modems or other such network interfaces that enables a computing device to intelligently connect to multiple different networks. Thus, if one particular network connection goes down, is running slow or is otherwise not accessible to the computing device, the network-access device may connect to another network to which it has access.

### BACKGROUND

In today's world of global communication, a computing device that does not have access to a network is practically useless. Therefore, when a network connection for a particular computing device is down or is otherwise not accessible to the computing device, it would be beneficial if the computing device could have access to another network connection.

### SUMMARY

The present application describes a network-access device with multiple different modems or other such network interfaces that enables a computing device to intelligently connect to multiple different networks. Thus, if one particular network connection goes down, is running slow or is otherwise not accessible to the computing device, the network-access device may connect to another network to which it has access. For example, the network-access device may include a first modem that enables the computing device to connect to or otherwise access a first type of network (e.g., an access network provided by an internet service provider) and a second modem that enables the computing device to connect to or otherwise access a second type of network (e.g., a 4G or 5G cellular or wireless network).

In addition to having multiple modems, the network-access device may include an intelligent traffic controller that can route traffic to/through each of the different modems based, at least in part, on different network conditions and availability. The intelligent traffic controller can also control the flow of data based on Quality of Service (QoS)/Class of Service (CoS) considerations, device type, data type, application, status of interfaces, etc. As the network-access device transitions between the different modems and networks, the transitions may be transparent to the end user of the computing device. Thus, as far as the end user is concerned, she always has access to a network.

Accordingly, the present application describes a network-access device that includes a first modem for connecting a client device to a first network and a second modem for connecting the client device to a second network. In some examples, the second network is of a different type than the first network. The network-access device also includes a processor and a memory coupled to the processor. The memory stores instructions that, when executed by the processor, cause the network-access device to monitor performance characteristics of the first network and the second network. The performance characteristics may further be used to determine, using a network bandwidth usage model, an anticipated network bandwidth requirement of the client device for a period of time and automatically select, based on the performance characteristics and the anticipated network bandwidth requirement, the first network. The instructions may also cause the client device to connect to the selected first network through the first modem during the period of time of anticipated usage.

Also described is a network-access device that includes a processor operable to select a network connection from a plurality of available network connections in which at least two of the network connections are of different network types. The network-access device may also include a memory that stores access credentials for each network connection of the plurality of network connections and a network performance monitor system that monitors performance characteristics of each network connection of the plurality of network connections. The network-access device may also include a first modem that enables a client device to connect to a first network connection of the plurality of available network connections and a second modem that enables the client device to connect to a second network connection when monitored performance characteristics of the first network connection fall below a network performance threshold.

Also described is a method for providing network access to a computing device. The method includes monitoring performance characteristics of a plurality of network connections and determining, using a stored network bandwidth usage model, an anticipated network bandwidth requirement. A determination may then be made as to whether a current network connection via a first modem of the network-access device has available bandwidth to handle the anticipated network bandwidth requirement. When it is determined the current network connection does not have available bandwidth to handle the anticipated network bandwidth requirement, at least one of the plurality of network connections is automatically selected based, at least in part, on the performance characteristics of each of the plurality of network connections. Once the at least one of the plurality of network connections is automatically selected, the client device can connect to a second modem that is associated with the selected at least one of the plurality of network connections.

This summary is provided to introduce a selection of concepts in a simplified form that are further described below in the Detailed Description. This summary is not intended to identify key features or essential features of the claimed subject matter, nor is it intended to be used to limit the scope of the claimed subject matter.

### BRIEF DESCRIPTION OF THE DRAWINGS

Non-limiting and non-exhaustive examples are described with reference to the following Figures.

FIG. 1 illustrates an example environment in which a network-access device having multiple modems may be used according to one or more examples.

FIG. 2 illustrates example components and systems that may be included in a network-access device according to one or more examples.

FIG. 3 illustrates an example user interface that may be provided to an end user to enable the end user to see the status of available networks according to an example.

FIG. 4 illustrates a method for enabling a client device to connect to a network using the network-access device described herein according to one or more examples.

FIG. 5 is a block diagram of a computing device according to one or more examples.

### DETAILED DESCRIPTION

In the following detailed description, references are made to the accompanying drawings that form a part hereof, and in which are shown by way of illustrations specific embodiments or examples. These aspects may be combined, other aspects may be utilized, and structural changes may be made without departing from the present disclosure. Examples may be practiced as methods, systems or devices. Accordingly, examples may take the form of a hardware implementation, an entirely software implementation, or an implementation combining software and hardware aspects. The following detailed description is therefore not to be taken in a limiting sense, and the scope of the present disclosure is defined by the appended claims and their equivalents.

The present disclosure describes a network-access device that enables a computing device (e.g., a laptop computer, desktop computer, mobile phone, tablet, set-top box, gaming device, etc.) to access a number of different networks (e.g., access networks, wireless networks, cellular networks, etc.) and seamlessly transition between the networks based on various user preferences and/or performance characteristics associated with those networks. In some examples, the network-access device may include multiple modems that enable the computing device to access the different types of networks based on, for example, a connectivity status of the networks, the available bandwidth of the networks, the type of data being sent over the networks, the type of computing device being connected to the networks and so on.

Although the examples described herein relate to switching networks based on various performance characteristics, the concepts described herein may also be applicable to a network service turn-up. For example, a new customer to an internet service provider could use the network-access device to connect to an existing wireless network via one or more discoverable access points and get services running before the access network was provisioned. Once the access network is provisioned, the network-access device could use the wireless, cellular, and access network to route traffic such as described below.

In order to accomplish the above, the network-access device may include an intelligent traffic controller that detects or otherwise determines which networks are available to and/or accessible by the network-access device. In some examples, the intelligent traffic controller may include or otherwise have access to a storage device that stores access credentials for each of the available networks. Thus, the network-access device may be able to switch seamlessly between various network connections as needed.

For example, using current and/or past data usage patterns (also referred to herein as a network bandwidth usage model), the intelligent traffic controller may determine or otherwise predict an anticipated network bandwidth requirement of the computing device for a period of time. This may also include determining the type of data and/or quantity of data being sent to and from the computing device. Using this information, the network-access device may select the network that can provide the desired amount of bandwidth to transfer the type and quantity of data.

In some examples, the intelligent traffic controller of the network-access device can route traffic to and/or from the computing device across the different modems simultaneously or substantially simultaneously thereby combining bandwidth. For example, if the computing device is sending thirty megabytes of data, the intelligent traffic controller may cause the first modem to handle ten megabytes of the data while the second modem may be assigned to handle the remaining twenty megabytes of data.

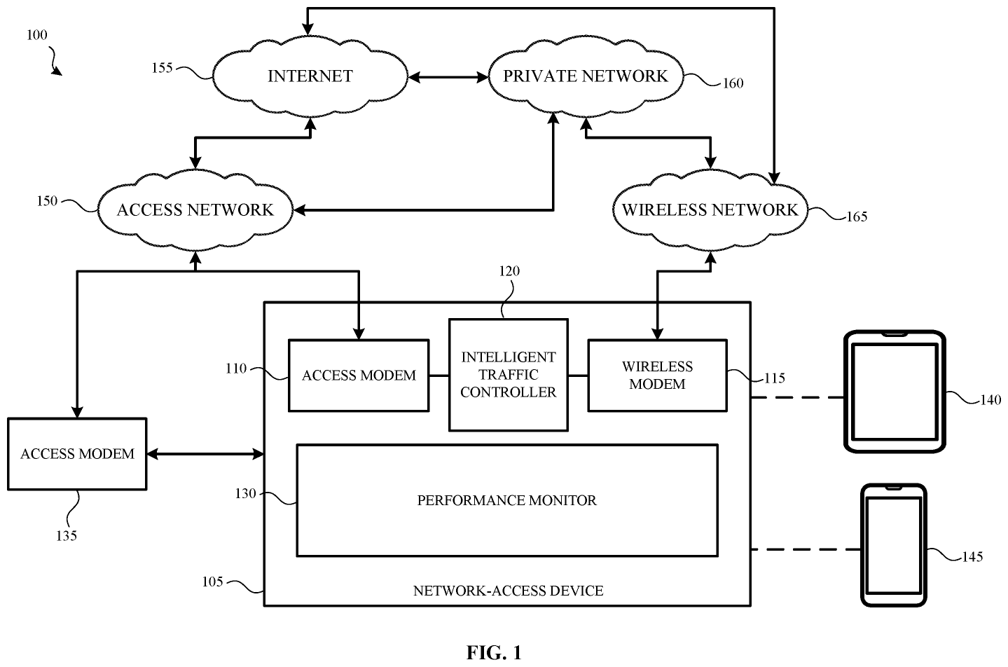

These and other examples will be explained in more detail below with respect to FIGS. 1-5.

FIG. 1 illustrates an example environment 100 in which a network-access device 105 having multiple modems (e.g., an access modem 110 and a wireless modem 115) may be used according to one or more examples. The network-access device 105 may enable a computing device (e.g., computing device 140 and/or computing device 145) to connect to and receive/transmit data across multiple different networks simultaneously or substantially simultaneously. Thus, if one network goes down, is running slow, or is otherwise not accessible to the computing device 140, the network-access device 105 may be able to select and connect the computing device 140 to a different network. Accordingly, the computing device 140 may essentially always have network access. Additionally, as the network-access device 105 switches between the various modems and networks, the changes are transparent to the end user such that the end user experiences little to no interruption with her connection.

As shown in FIG. 1, the network-access device 105 may include two (or more) modems. Each of the modems may be used to access a different type of network. For example, the network-access device 105 may include an access modem 110 and a wireless modem 115. Although specific modems are mentioned, the network-access device 105 may have any number of different (or similar) types of modems.

The access modem 110 may provide the computing device 140 access to a first type of network. In the example shown in FIG. 1, the access modem 110 provides the computing device 140 access to an access network 150. In some examples, the access network 150 may be provided by a DSL or cable internet service provider. Once the computing device 140 has been connected to the access network 150 via the network-access device 105, the computing device 140 may have access to the internet 155 and/or a private network 160.

The wireless modem 115 may provide the computing device 140 access to a second type of network. The second type of network may be different from the first type of network. In the example shown in FIG. 1, the wireless modem 115 provides the computing device 140 access to a wireless network 165. In some examples, the wireless network 165 may be a cellular network provided by a mobile service provider, a public or private Wi-Fi network or the like. As with the access network 150, when the computing device 140 is connected to the wireless network 165 via the network-access device 105, the computing device 140 may access the internet 155 and/or a private network 160.

The network-access device 105 may also include an intelligent traffic controller 120. The intelligent traffic controller 120 may be responsible for ensuring that the computing device 140 has continuous and/or uninterrupted access to a network. Therefore, the intelligent traffic controller 120 may be responsible for determining the status of each network to which the network-access device 105 has access and also selecting which network and modem to use.

For example, the network-access device 105 may enter a network discovery phase and determine various access points to which it can connect. Once login credentials for the networks are provided (if required) to the network-access device 105, the computing device 140 can access the network and receive/transmit data.

In the following example, the computing device 140 is connected to the access network 150 via the access modem 110. At some point in time, the intelligent traffic controller 120 may determine that the access network 150 is down and/or that the access network 150 is performing below a network performance threshold.

In some examples, the end user may specify the bounds of the network performance threshold. The network performance threshold may be based, at least in part, on a particular type of application executing on the computing device and/or the type of data transmitted over the network. For example, if the end user is participating in a VoIP call, a minimum network performance threshold may be a ten megabyte per second transfer rate. However, if the individual is streaming a movie, a minimum network performance threshold may be a five megabyte per second transfer rate. Although specific minimum thresholds are given, these are for example purposes only.

Returning to the example, once the intelligent traffic controller 120 determines that the current network is operating below the network performance threshold, the intelligent traffic controller 120 will automatically (e.g., without intervention or instructions from the end user of the computing device 140) route data through the another network for which access credentials have been received. For example, the intelligent traffic controller 120 may route some or all of the data over the wireless modem 115 and wireless network 165.

In some examples, the intelligent traffic controller 120 may cause a user interface and/or a message to be displayed on a computing device associated with the end user informing the end user that access to another network may be associated with a cost. For example, although the end user may have access credentials to another network (e.g., a cellular network or a wireless network), use of the network may cost the end user $5.00 per hour.

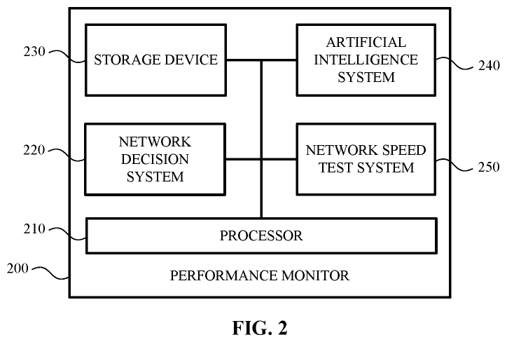

In this way, a first network service provider may team up with another network service provider and offer their customers an “always connected” option. For example, the first network service provider may provide access credentials to the customers of the second network service provider. The access credentials may be offered as an emergency use option that may be used weekly, monthly, bimonthly, etc. In some examples, the emergency use option may be a free service offered by the network service providers or may be associated with a cost such as described above. The cost may be billed by the first network service provider or the second network service provider. In such examples, the intelligent traffic controller 120 may track the connection and use of the various networks provided by the different network service providers and provide this information to a storage device (e.g., storage device 230 (FIG. 2)) for subsequent billing purposes. In other examples, payment for use of the network may be collected at the time of use (e.g., by requiring the end user to enter payment information for use of the network).

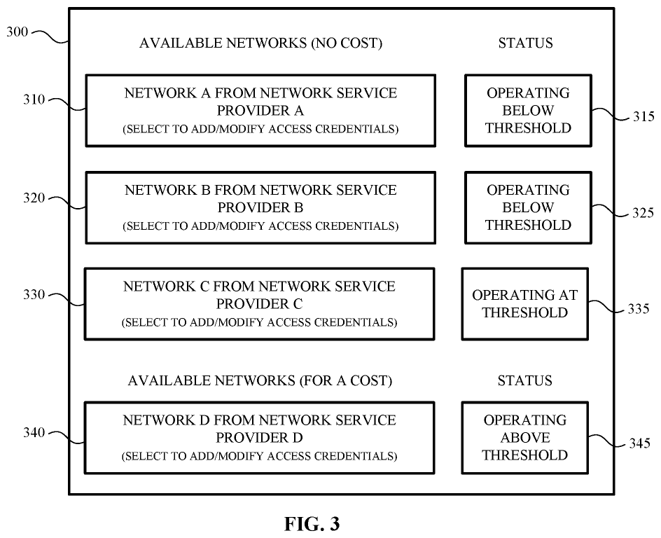

For example and turning to FIG. 3, FIG. 3 illustrates an example user interface 300 that may be generated and/or provided by an intelligent traffic controller (e.g., intelligent traffic controller 120 (FIG. 1)) of a network-access device (e.g., network-access device 105 (FIG. 1)). In this example, the user interface 300 provides a list of networks and/or network service providers for which the end user has access. In the example shown, the end user has access to network A from service provider A 310, has access to network B from service provider B 320 and has access to network C from service provider C 330. As indicated in the user interface 300, the end user has access to network A, network B and/or network C without incurring any costs. However, the end user may also have access to network D from service provider D. As shown on the user interface 300, use of network D is associated with a cost.

Additionally, the user interface 300 shows the operating status of each of the networks. For example, network A 310 is operating below a threshold 315 (e.g., the minimum threshold specified by the end user and/or a minimum threshold determined by the intelligent traffic controller based, at least in part, on the determined/anticipated activity of the end user), network B 320 is operating below a threshold 325, network C 330 is operating at the threshold 335 and network D 340 is operating above a threshold 345.

In some examples, the end user may select one or more of the networks displayed in the user interface 300 and provide and/or modify access credentials associated with each of the networks. Additionally, the user interface 300 may provide one or more input fields that enable the end user to provide payment information for use of the networks that are associated with a cost.

Referring back to FIG. 1, in some examples, the switch and subsequent routing of data through the different modems and networks may be temporary and/or may expire after a particular time frame (e.g., one hour, thirty minutes, one minute, thirty seconds, etc.) has passed. For example, if the intelligent traffic controller 120 switches modems/networks such as described above, the intelligent traffic controller 120 may periodically check (e.g., every one minute, every five minutes, every twenty minutes, etc.) the access modem 110 and/or the access network 150 to determine whether service has been restored or whether current data transfer rates have exceeded the network performance threshold.

If service to the access network 150 has been restored or the network performance threshold is being met, the intelligent traffic controller 120 may automatically switch back to routing data through the access network 150 via the access modem 110. If not, the intelligent traffic controller 120 will continue to route data through the wireless modem 115 and wireless network 165.

In some examples and prior to switching to a particular network and/or back to a particular network, the intelligent traffic controller 120 may determine one or more performance characteristics/metrics of the network. If the network does not have performance characteristics that can meet a current bandwidth requirement or an anticipated network bandwidth requirement (e.g., based on a network bandwidth usage model), the intelligent traffic controller 120 will not switch modems/networks.

Continuing with the example above, if the intelligent traffic controller 120 determines that the access network 150 is back online but current network traffic conditions on the access network 150 are limited to five megabytes per second, and the end user is currently running an application on the computing device 140 that requires data transmission of ten megabytes per second, the intelligent traffic controller 120 would not switch networks until the determined one or more performance characteristics/metrics of the network meet or exceed the current or anticipated needs of the end user and/or the end user no longer has need of the bandwidth (e.g., the end user finishes her VoIP call).

The network-access device 105 may also be responsible for ensuring that the current or anticipated network bandwidth requirements of the computing device 140 are being met. If the current and/or anticipated network bandwidth requirements are not being met by the network the network-access device 105 is currently connected to, the intelligent traffic controller 120 may access a different network via one of its modems.

For example, if the computing device 140 is connected to the access network 150 via the network-access device 105 and the intelligent traffic controller 120 determines that the access network 150 is performing under a network performance threshold (e.g., due to heavy network traffic), the intelligent traffic controller 120 may begin to route data to and from the computing device 140 via the wireless modem 115 and wireless network 165.

In another example, the network-access device 105 may connect to one of the networks via another computing device. For example, the network-access device 105 may connect to the wireless network 165 via a hotspot on a mobile computing device such as, for example, computing device 145.

In another example, the intelligent traffic controller 120 may determine or otherwise have knowledge that the network-access device 105 can route data through, or is otherwise connectable to, another access modem 135. In some examples, the access modem 135 may be part of a different network-access device. Like the access modem 110, the access modem 135 may provide access to an access network 150. Although FIG. 1 illustrates that the access modem 110 and the access modem 135 connect to the same access network 150, this is not required and each access modem can access different access networks.

For example, the access modem 110 can access a first access network provided by a first internet service provider and the access modem 135 can access a second access network provided by a second internet service provider. Additionally, although FIG. 1 shows that the network-access device 105 accesses another access modem 135, the network-access device 105 can connect to any type of modem (e.g., a wireless modem) included or otherwise associated with another network-access device.

The network-access device 105 can also support multiple simultaneous connections to different networks via various modems and access points and route different amounts of data across each one simultaneously or substantially simultaneously. In some examples, selection and use of multiple networks and access points may be based on current and/or anticipated network bandwidth requirements of the computing device 140 and/or on one or more performance characteristics of the various networks.

For example, if the intelligent traffic controller 120 determines that an application executing on the computing device requires a data transmission rate of forty megabytes per second, the intelligent traffic controller 120 may route a first portion of the data across a first modem and network (e.g., ten megabytes over the access modem 110 and access network 150), a second portion of the data across a second network (e.g., ten megabytes over the wireless modem 115 and the wireless network 165) and a third portion of the data across a third network (e.g., twenty megabytes over the access modem 135 and access network 150). As with the other examples described herein, the selected networks and the amount of data transferred over the networks may be based on various performance characteristics and/or network bandwidth usage models determined by the intelligent traffic controller 120.

In order to intelligently determine how to route data through various networks, the intelligent traffic controller 120 may have or otherwise be associated with a performance monitor 130. The performance monitor 130 enables the intelligent traffic controller 120 to determine which networks are accessible/available to the network-access device 105, track or otherwise determine various performance characteristics of the various networks, receive and store access credentials to the various networks, determine and/or track anticipated network bandwidth requirements of the computing device 140, determine and/or track current network bandwidth requirements of the computing device 140 and so on.

For example, the intelligent traffic controller 120 and/or the performance monitor 130 may subscribe to and receive notifications from certain applications running on the client device(s). For example, a calendar application may notify the performance monitor 130 that a particular event is scheduled for a particular time period (e.g., a VOIP call or video conference). The performance monitor 130 may, before such event, monitor the performance of the various available networks and ensure that the network chosen and connected at the time of the event can handle the event for the specified time period. Additionally, the performance monitor 130 can provide a warning or other notification that one of the subscribed-to networks is experiencing intermittent outages. As such, the end user may be given an option to use a more stable network (e.g., such as, for example, one of the networks listed in the user interface 300 (FIG. 3)).

FIG. 2 illustrates example components and systems of a performance monitor 200 that may be included in or otherwise associated with a network-access device. In some examples, the performance monitor 200 may be equivalent to the performance monitor 130 shown and described with respect to FIG. 1. As such, the performance monitor 200 may be used by or in association with an intelligent traffic controller (e.g., intelligent traffic controller 120 (FIG. 1)) of a network-access device (e.g., network-access device 105 (FIG. 1)) to help ensure a computing device has access to a network.

In some examples, the performance monitor 200 includes a processor 210. The processor 210 may provide instructions to or otherwise control the other systems and components of the performance monitor 200.

The performance monitor 200 may also include a network decision system 220. The network decision system 220 may communicate with the other components/systems in the performance monitor 200 when determining which modem and network the network-access device should access and use. The network decision system 220 may also determine whether and when bandwidth across various modems should be combined.

The performance monitor 200 may also include a storage device 230. The storage device 230 may store access credentials for the various networks. For example, the network decision system 220 may determine or otherwise identify various network access points to which the network-access device can connect. Once discovered, the network decision system 220 may cause the generation of a user interface that may be displayed on a computing device. The user interface may be used to receive access credentials for the various access points and networks. As access credentials are received, the information is stored in the storage device 230 and may subsequently be used by the intelligent traffic controller as needed when the network-access device connects to the various networks.

The performance monitor 200 may also include an artificial intelligence system 240. The artificial intelligence system 240 may be used determine current and/or anticipated bandwidth usage requirements of a computing device and/or one or more applications executing on the computing device. In some examples, the anticipated bandwidth usage requirements may be determined by monitoring network usage activity of an end user over a period of time.

For example, the artificial intelligence system 240 may determine, based on a tracked or determined bandwidth usage history, that the end user of the computing device has a VoIP call every Wednesday and Friday at 12:00. On Wednesday, the VoIP call lasts for thirty minutes. On Friday, the VoIP call lasts for one hour. Additionally, the artificial intelligence system 240 may determine that the VoIP call requires a minimum forty megabytes per second transfer rate.

Once this information is determined, the network decision system 220 may be able determine which available access point and network (or combination of access points and networks) can provide the required amount of bandwidth on those days and at those times for the required duration of time. As the day and time for the VoIP call approaches, the network decision system 220 may cause the network-access device to automatically establish connections with the particular network or networks that can provide the desired amount of bandwidth (presuming for example, that the current network connection does not have the available bandwidth). In some examples, once the duration of time is complete, the network decision system 220 may cease using one or more of the modems and networks and/or switch back to a previously used modem and network. In some examples, if a selection of one of the available access points and/or networks is not selected within a threshold amount of time (e.g., one minute or more, two minutes or more, etc.), the last known working network connection is maintained until a selection is received.

In other examples, if an interface to a particular network is lost and there is only one network interface available for a selection, certain functionality (e.g., network selection/determination functionality) of the artificial intelligence system 240 may be suspended until such time as the network interface is restored. For example, if the performance monitor 200 determines that only one network connection is currently available, a decision as to which network to connect to would not be needed. As such, any artificial intelligence system 240 determinations may not be needed.

The artificial intelligence system 240 may also determine the type of computing device and/or application that is utilizing or otherwise requesting the bandwidth. Once this is determined, the artificial intelligence system 240 may assign or otherwise select various networks based, at least in part, on this information. For example, the artificial intelligence system 240 may receive an identifier or otherwise determine whether a desktop computer, set-top box, gaming machine, mobile phone, tablet computer, etc. is requesting access to one or more networks. The artificial intelligence system 240 may also determine the purpose of the bandwidth request. In some examples, the purpose of the bandwidth request may be based, at least in part, on an application executing on the computing device.

For example, if the computing device is a set-top box and/or the end user is streaming a movie, the artificial intelligence system 240 may determine (either automatically and/or based on received user input) that the network-access device should not connect to a wireless service (e.g., 4G or 5G service provider) due to data limits and/or associated cost with using the network or going over a data limit. However, the set-top box may be able to connect to another access modem (e.g., an access modem associated with another network-access device) such as described above. Thus, the artificial intelligence system 240 may be able to intelligently select various networks and combination of networks based on current bandwidth usage requirements and anticipated bandwidth usage requirements based on various factors including a determined use of the bandwidth and/or the type of computing device that is accessing the network.

In some examples, the artificial intelligence system may also track the amount of time a particular computing device is connected to a particular network. In some examples, if the amount of time that a computing device is connected to particular network exceeds a threshold amount of time (or an amount of data transferred over the particular network exceeds a data transfer threshold) the network decision system 220 may cease using or otherwise restrict the use of that particular network for a period of time.

For example, if the network decision system 220 connects the computing device to a wireless 5G network, the network decision system 220 and/or the artificial intelligence system 240 may restrict access to the 5G wireless network after twenty minutes and/or once one gigabyte of data has been transferred over that network to help ensure the end user does not exceed a data limit (if any) for that particular network and as a result, incur extra costs.

The network decision system 220 may also select one or more networks based, at least in part, on preferences specified by the end user. In some examples, those preferences may be based on the type of activity the end user is engaged in. For example, the end user may specify that VoIP calls should receive the highest quality of service. As such, when the end user is participating in a VoIP call, the network decision system 220 and/or the artificial intelligence system 240 may determine which network(s) and access point(s) will provide the highest quality of service.

In other examples, the end user may specify a hierarchal arrangement of networks. This arrangement may specify a failover order of the various access points and networks the network-access device can access. In other examples, the hierarchical arrangement may be determined automatically. For example, the hierarchical arrangement may be based on overall dependability of a particular network, a strength of signal, bandwidth limitations or availability during different times of the day or days of the week, etc. In some examples, the hierarchical arrangement of networks may be computing device specific and/or application specific.

For example, a set-top box may be associated with a first hierarchical arrangement of networks while a computing device may be associated with a second hierarchical arrangement of networks. In additional examples, the end user may be able to specify that certain types of network traffic go over certain interfaces. For example, the end user may specify that data relating to VoIP calls can be transmitted over an access network or a cellular network but not a wireless network. Likewise, the end user may specify that streaming data can be transmitted over an access network or a wireless network but not a cellular network. The hierarchical arrangement of networks may be stored in the storage device 230.

The performance monitor 200 may also include a network speed test system 250. In some examples, the network speed test system 250 may test or otherwise determine the performance characteristics of the various networks the network-access device can access. This includes, but is not limited to pinging the various networks, running speed tests on the various networks, sending packets to the various networks to see if they are available, etc.

The network speed test system 250 may execute one or more of these tests periodically (e.g., on a set schedule), randomly, in response to an approaching anticipated network bandwidth use, and/or in response to determine that a current network connection is or is not providing the desired amount of bandwidth to the requesting computing device. Using the information obtained by the network speed test system 250, the performance monitor 200 may be able to intelligently select which networks to access.

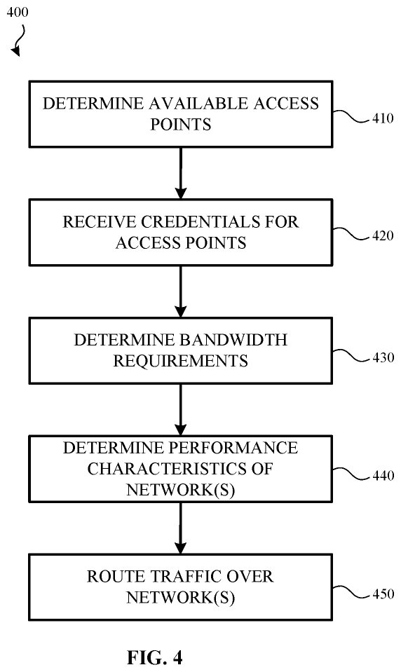

FIG. 4 illustrates a method 400 for enabling a client device to connect to a network using the network-access device described herein according to one or more examples. In some examples, the method 400 may be used by the network-access device 105 shown and described with respect to FIG. 1.

Method 400 begins when a network-access device determines (410) one or more access points it can reach or otherwise communicate with. In some examples, this includes causing the network-access device to enter a discovery phase. During the discovery phase, the network-access device may determine that is has access to a number of different networks including, but not limited to wireless networks, Wi-Fi networks, cellular networks, wired networks, etc. In some examples, some of the networks may be public and some of the networks may be private.

Once the available access points and networks are discovered, access credentials for the various access points/networks may be received (420). In some examples, the network-access device may provide a user interface on a computing device that enables an end user to provide a username, password, PIN or other such access credentials that show or otherwise indicate the end user has permission to access a particular network.

In some examples, the user interface may also enable the end user to specify a hierarchical arrangement of the available networks. The hierarchical arrangement of networks may include a network connection failover preference in which the end user specifies an order or arrangement of networks the network-access device should connect to in the event that the current network fails or is not meeting the requested or desired bandwidth requirements. The hierarchical arrangement may also be based on the type of data being transmitted over the network, the type of application receiving/transmitting the data, and/or the type of computing device receiving/transmitting the data. In other examples, the arrangement of the hierarchy may be automatically determined by the network-access device but editable by the end user.

The user interface may also enable the end user to specify a particular network that the network-access device can access in the event that the current network connection cannot meet the current or anticipated bandwidth requirements. For example, the end user may provide information about a mobile hotspot in the user interface. When this information is provided, the network-access device can connect to a wireless network via the mobile device in response to a detected failover event.

The network-access device may also determine (430) current and/or anticipated bandwidth requirements of a computing device and/or application executing on the computing device. In some examples, the anticipated bandwidth requirements may be based, at least in part, on a network bandwidth usage history associated with the computing device and/or application.

Once the bandwidth requirements are determined, the network-access device can determine (440) one or more performance characteristics of the various networks. Based on the performance characteristics, the network-access device routes (450) traffic over one or more networks such as described above.

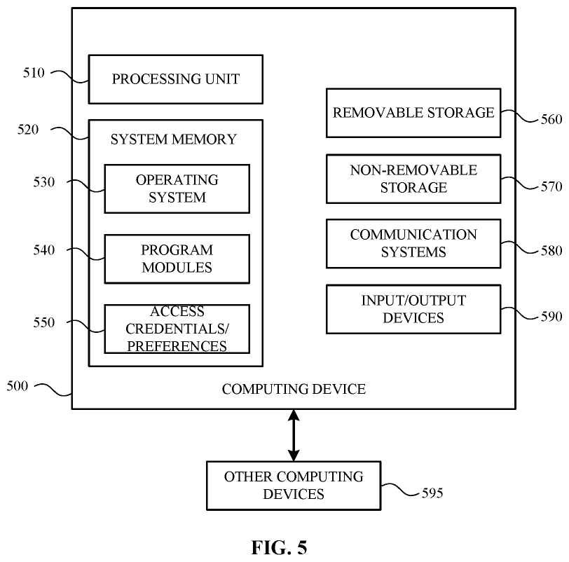

FIG. 5 is a system diagram of a computing device 500 according to an example. The computing device 500, or various components and systems of the computing device 500, may be integrated or associated with a network-access device such as described herein. As shown in FIG. 5, the physical components (e.g., hardware) of the computing device are illustrated and these physical components may be used to practice the various aspects of the present disclosure.

The computing device 500 may include at least one processing unit 510 and a system memory 520. The system memory 520 may include, but is not limited to, volatile storage (e.g., random access memory), non-volatile storage (e.g., read-only memory), flash memory, or any combination of such memories. The system memory 520 may also include an operating system 530 that controls the operation of the computing device 500 and one or more program modules 540. The program modules 540 may be responsible for gathering or determining network access credentials, network hierarchy information and so on. The memory 520 may also store and/or provide access credentials and/or end user preferences (e.g., network hierarchy, network connection failover preferences, etc.) such as described above. A number of different program modules and data files may be stored in the system memory 520. While executing on the processing unit 510, the program modules 540 may perform the various processes described above.

The computing device 500 may also have additional features or functionality. For example, the computing device 500 may include additional data storage devices (e.g., removable and/or non-removable storage devices) such as, for example, magnetic disks, optical disks, or tape. These additional storage devices are labeled as a removable storage 560 and a non-removable storage 570.

Examples of the disclosure may also be practiced in an electrical circuit comprising discrete electronic elements, packaged or integrated electronic chips containing logic gates, a circuit utilizing a microprocessor, or on a single chip containing electronic elements or microprocessors. For example, examples of the disclosure may be practiced via a system-on-a-chip (SOC) where each or many of the components illustrated in FIG. 5 may be integrated onto a single integrated circuit. Such a SOC device may include one or more processing units, graphics units, communications units, system virtualization units and various application functionality all of which are integrated (or “burned”) onto the chip substrate as a single integrated circuit.

When operating via a SOC, the functionality, described herein, may be operated via application-specific logic integrated with other components of the computing device 500 on the single integrated circuit (chip). The disclosure may also be practiced using other technologies capable of performing logical operations such as, for example, AND, OR, and NOT, including but not limited to mechanical, optical, fluidic, and quantum technologies.

The computing device 500 may include one or more communication systems 580 that enable the computing device 500 to communicate with other computing devices 595, network-access devices, access points and the like. Examples of communication systems 580 include, but are not limited to, wireless communications, wired communications, cellular communications, radio frequency (RF) transmitter, receiver, and/or transceiver circuitry, a Controller Area Network (CAN) bus, a universal serial bus (USB), parallel, serial ports, etc.

The computing device 500 may also have one or more input devices and/or one or more output devices shown as input/output devices 590. These input/output devices 590 may include a keyboard, a sound or voice input device, haptic devices, a touch, force and/or swipe input device, a display, speakers, etc. The aforementioned devices are examples and others may be used.

The term computer-readable media as used herein may include computer storage media. Computer storage media may include volatile and nonvolatile, removable and non-removable media implemented in any method or technology for storage of information, such as computer readable instructions, data structures, or program modules.

The system memory 520, the removable storage 560, and the non-removable storage 570 are all computer storage media examples (e.g., memory storage). Computer storage media may include RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other article of manufacture which can be used to store information and which can be accessed by the computing device 500. Any such computer storage media may be part of the computing device 500. Computer storage media does not include a carrier wave or other propagated or modulated data signal.

Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media.

The description and illustration of one or more aspects provided in this application are not intended to limit or restrict the scope of the disclosure as claimed in any way. The aspects, examples, and details provided in this application are considered sufficient to convey possession and enable others to make and use the best mode of claimed disclosure. The claimed disclosure should not be construed as being limited to any aspect, example, or detail provided in this application. Regardless of whether shown and described in combination or separately, the various features (both structural and methodological) are intended to be selectively rearranged, included or omitted to produce an embodiment with a particular set of features. Having been provided with the description and illustration of the present application, one skilled in the art may envision variations, modifications, and alternate aspects falling within the spirit of the broader aspects of the general inventive concept embodied in this application that do not depart from the broader scope of the claimed disclosure.

1. A network-access device, comprising:
a first modem for connecting a client device to a first network;
a second modem for connecting the client device to a second network, wherein the second network is of a different type than the first network;
a processor; and
a memory coupled to the processor and storing instructions that, when executed by the processor, cause the network-access device to:
monitor performance characteristics of the first network and the second network;
determine, using a network bandwidth usage model, an anticipated network bandwidth requirement of the client device for a period of time, wherein the anticipated network bandwidth requirement is based, at least in part, on an application that accesses the selected first network for the period of time and a required data transmission rate for the application;
automatically selecting, based on the performance characteristics and the anticipated network bandwidth requirement, the first network; and
causing the client device to connect to the selected first network through the first modem during the period of time.

2. The network-access device of claim 1, further comprising instructions for causing the client device to connect to the second network through the second modem when the monitored performance characteristics of the first network fall below a network performance threshold.

3. The network-access device of claim 1, wherein the network usage model is based, at least in part, on a network bandwidth usage history associated with the client device.

4. (canceled)

5. The network-access device of claim 1, the memory further storing access credentials for the first network and the second network.

6. The network-access device of claim 1, further comprising instructions for determining one or more access points associated with the first network and the second network.

7. The network-access device of claim 1, further comprising instructions for routing a first portion of data through the first network and routing a second portion of data through the second network.

8. The network-access device of claim 1, further comprising instructions for receiving input that arranges the first network and a second network in a network preference hierarchy.

9. The network-access device of claim 8, further comprising instructions for:
detecting that the selected first network is unavailable; and
automatically selecting the second network in the network preference hierarchy.

10. A network-access device, comprising:
a processor operable to select a network connection from a plurality of available network connections, at least two of the network connections being of different network types;
a memory storing access credentials for each network connection of the plurality of network connections;
a network performance monitor system that monitors performance characteristics of each network connection of the plurality of network connections;
a first modem that enables a client device to connect to a first network connection of the plurality of available network connections;
a second modem that enables the client device to connect to a second network connection when monitored performance characteristics of the first network connection fall below a network performance threshold; and
an artificial intelligence system that determines anticipated network bandwidth requirements for the client device for a period of time, wherein the anticipated network bandwidth requirement is based, at least in part, on an application that accesses the selected first network for the period of time and a required data transmission rate for the application, wherein
the client device connects to the first network connection through the first modem during the period of time.

11. (canceled)

12. The network-access device of claim 10, wherein the artificial intelligence system determines the anticipated network bandwidth based, at least in part, on a determined network usage history.

13. The network-access device of claim 10, wherein the artificial intelligence system determines the anticipated network bandwidth based, at least in part, on a particular application being executed by the client device.

14. The network-access device of claim 10, wherein the memory stores instructions that, when executed by the processor, provides a user interface on the client device that enables a selection of a third network connection of the plurality of available network connections for temporary use.

15. The network-access device of claim 14, wherein use of the third network connection for the temporary use is associated with a cost.

16. The network-access device of claim 10, wherein the memory stores a hierarchical arrangement of the plurality of available network connections, the hierarchical arrangement specifying a network connection failover preference.

17. The network-access device of claim 10, wherein the first network connection provides a first amount of bandwidth to the client device and the second network connection provides a second amount of bandwidth to the client device substantially simultaneously.

18. A method performed by a network-access device, comprising,
monitoring performance characteristics of a plurality of network connections;
determining, using a stored network bandwidth usage model, an anticipated network bandwidth requirement for a period of time;
determining whether a current network connection via a first modem of the network-access device has available bandwidth to handle the anticipated network bandwidth requirement, wherein the anticipated network bandwidth requirement is based, at least in part, on an application that accesses the current network connection for the period of time and a required data transmission rate for the application;
when it is determined the current network connection does not have available bandwidth to handle the anticipated network bandwidth requirement, automatically selecting at least one of the plurality of network connections based, at least in part, on the performance characteristics of each of the plurality of network connections; and
causing a client device to connect to a second modem that is associated with the selected at least one of the plurality of network connections.

19. The method of claim 18, wherein the client device is connected to the first modem and the second modem simultaneously.

20. (canceled)
